(19) United States
(12) Patent Application Publication
(10) Pub. No.: US 2003/0136112 A1
(43) Pub. Date: Jul. 24, 2003

(54) Central turbo ducted fan integrated power plant unit

(76) Inventor: Kit Wah Li, Kowloon (HK)

Correspondence Address: RABIN & BERDO, P.C., Suite 500, 1101 14th Street, Washington, DC, 20005, US

(21) Appl. No.: 10/050,141

(22) Filed: Jan. 18, 2002

(51) Int. Cl. F02K 5/02

(52) U.S. Cl. 60/269; 60/770

(57) ABSTRACT

A central turbo ducted fan integrated power plant unit comprises a central turbine having turbine blades and retaining ring, fan duct stator, internal combustion engine, fuel tank. There are provided central turbine blades on the retaining ring. The fan duct stator includes an outer ring, an inner ring, stator guide blades, turbine guide blades and the fixing supports on which the internal combustion engine and fuel tank are fixed. The central turbine is mounted on the fan duct stator and the inner hole or guide hole containing the central turbine blades is communicated with the inner hole of the inner ring. On the front end of the fan duct stator is provided a guide ring with diameter or inner diameter being reduced gradually from the front toward the rear, thereby the volume of air flow to be expelled can be increased and the air stream can be guided to be expelled linearly reward and the disordered air flow can be prevented from occurring. At the same time, the jetted air stream can cool the crankcase of the engine, thereby the success start rate and the propulsion force of the engine can be raised. The present utility model further has the advantages of simple and integrated structure, high efficiency and light weight.

The present utility model relates to a ducted fan power plant unit, more particularly relates to a central turbo ducted fan integrated power plant unit in which a turbine system is provided in the central portion of a ducted fan power plant unit.

### BACKGROUND OF THE INVENTION

At present, most ducted fan power plant units adopt the design of straight guide duce, i.e. the ducted fan and stator outer ring are linear. The diameter or area of the air intake port of the ducted fan is equal to that of the air outlet port of the stator, therefore when air is expelled rearward via the stator from the air outlet port after air is taken in by the ducted fan, the acceleration of the expelled air flow is only proportioned to the rotational speed of the engine. In addition, due to the fact that the diameter of the head spinner and the central shaft of the unit is relatively large so that the area of air flow taken in at the air intake port is reduced, when air is blown at high speed the amount of air admission often is not enough, the result is the reduction of engine efficiency, and when air flow is expelled rearward after passing through the stator outer ring and stator guide blades the disordered flow will occur in this region and air flow speed is adversely influenced because no air passes through the inner ring of the stator, resulting in the reduction of propulsion of the model airplane, at the same time, the surrounding region of the central portion of the engine suffers from poor cooling because no air flows or passes through there, thereby the engine cannot achieve good efficiency when operating at high-speed rotation. On the other hand, the existing model airplane ducted fan system suffers from relatively complicated structure, a greater number of components, heavier weight and too many working procedures needed in mounting as well as requiring higher operating technique. The result is, for most model airplanes amateurs and beginners, due to the non-ideal effect in use, many puzzles will occur in operation and manufacture of the model airplane, therefore improvement is urgently needed indeed.

The purpose of the present utility model is to overcome the above mentioned drawbacks and to provide a central turbo ducted fan integration power plant unit, said unit has a central turbine which can jet air flow in the central portion, and the central jet can synchronously function together with the jet of the ducted fan to improve and enhance the quality and the amount or volume of the flowing of the air.

### SUMMARY OF THE INVENTION

The technical scheme for achieving the above mentioned purpose is to provide a central turbo ducted fan integrated power plant unit, it comprises a central turbine having turbine blades and a turbine blade retaining ring, a fan duct stator, an internal combustion engine, a fuel tank and an air expelling duct, characterized in that, in the retaining ring several central turbine blades are provided, said fan duct stator has an outer ring and an inner ring which are connected through some connecting bars, and a fixing support provided on two sides of the inner ring, on which the internal combustion engine and fuel tank are disposed, said central turbine is mounted on the fan duct stator by means of a cone-shaped cover, and is mounted in such a manner that the guide hole which contains central turbine blades is communicated with the inner hole of the inner ring which contains the connecting bars.

As above mentioned central turbo ducted fan integrated power plant unit, wherein the connecting bars of the fan duct stator are the stator guide blades and several radially and uniformly spaced turbine guide blades are also provided on the inside surface of the inner ring.

As above mentioned central turbo ducted fan integrated power plant unit, wherein a central air intake guide ring with large outer diameter and small inner diameter is provided at the front end of the fan duct stator.

As above mentioned central turbo ducted fan integrated power plant unit, wherein it also comprises a tail cap for the fuel tank, said tail cap is mounted on the rear end of the fuel tank.

As above mentioned central turbo ducted fan integrated power plant unit, wherein the outer diameter of the end portion of the turbine blades is reduced gradually from the front to the rear and has approximately the same inclined angle as the inner wall of the cone-shaped air intake guide ring.

As above mentioned central turbo ducted fan integrated power plant unit, wherein the retaining ring of the central turbine is of a conical shape.

As above mentioned central turbo ducted fan integrated power plant unit, wherein the inner diameter of the air expelling duct is gradually reduced from the front to the rear.

It can be seen from the above that the central turbine of the central turbo ducted fan integrated power plant unit according to the present utility model has several central turbine blades which operate synchronously with the turbine blades to generate a jet flow of the central turbine, fan duct stator has turbine guide blades, stator guide blades and conically converging air intake guide ring, hence the amount of air supply blown can be increased and air flow can be guided to be expelled rearward linearly to prevent from the occurrence of disordered air flow. At the same time, the air flow jetted by the central turbine can cool the mixed gas in the crankcase of the engine and the density of the mixed gas can be increased, thereby the compression ratio can be increased, and the successful start rate and the propulsion can be improved or raised. The engine of central turbo ducted fan integrated power plant unit can use conventional engine of the two-stroke model airplane, the rotation of the engine makes the central turbo ducted fan take in the air at the front end, and pass it through conically converged air intake guide ring to enter the stator, expelled rearward through the stator guide blade of the fan duct stator, so as to join the air flow of the stator guide blade with the central turbine jet flow passed through the inner ring, passing then through air outlet duct and the fuel tank in the central position, expelling rearward air with large volume and at high speed to generate reaction force, and advancing forwardly the central turbo ducted fan integrated power plant unit, of which the function is equal to that of the jet propulsion engine of jet model airplane in use. The central turbo ducted fan integrated power plant unit according to the present utility model features also the simple and integrated structure, high efficiency and light weight.

### BRIEF DESCRIPTION OF DRAWINGS

FIG. 1 is a cut-away schematic view of the structure of an embodiment of the present utility model.

FIG. 2 is a plan view of FIG. 1.

FIG. 3 is a left view of FIG. 1.

FIG. 4 is a perspective view of the central fan guide tube stator in FIG. 1.

FIG. 5 is a schematic view of the flow state of the jet air flow when the central turbo ducted fan integrated power plan unit operates.

FIG. 6 is a perspective view of a pawl wheel starter for easy start of the unit.

### DETAILED DESCRIPTION OF PREFERRED EMBODIMENT

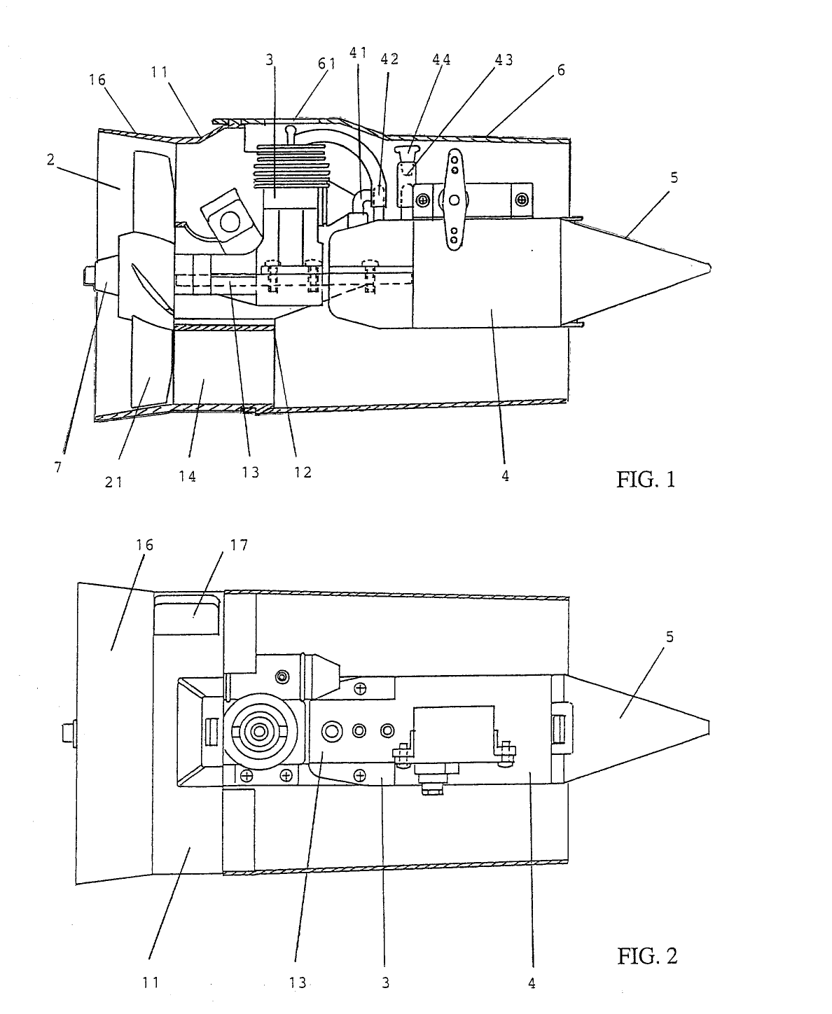

Please refer to FIG. 1 to FIG. 4, the central turbo ducted fan integrated power plant unit mainly comprises a fan duct stator 1, a central turbine 2, an internal combustion engine 3, a fuel, tank 4, a tail cap 5, an air expelling duct 6 and a conical cover 7. The fan duct stator 1 includes an outer ring 11, an inner ring 12, a fixing supports 13, in which, the outer ring 11 and the inner ring 12 are connected by several stator connecting bars, and the fixing supports 13 are provided on the both sides of the inner ring. In an embodiment of the present utility model, the connecting bars of the fan duct stator 1 are designed as stator guide blades 14 and function as the supports for the outer and the inner ring 11, 12, and on the inside surface of the inner ring are provided several radially and uniformly spaced turbine guide blades 15. In addition, a cone-shaped air intake guide ring 16 with diameter or inner diameter being reduced gradually from the front toward the rear is provided further at the front end of fan duct stator 1. A fixing member 17 for fixing the integrated power plant unit is disposed on the outer ring of the fan duct stator, with which the central turbo ducted fan integrated power plant unit can be easily mounted under the wings, in the duct or on the both sides of the outside fuselage.

The central turbine 2 has several turbine blades 21 and a turbine blade retaining ring 22. The retaining ring 22 is of a conic shape, in which several central turbine blades 23 are provided. The central turbine 2 is mounted on the fan duct stator 1 via cone-shaped cover 7 so that the cover 7 is partially placed against the front portion of the central turbine blades 23, and at the same time, the guide hole or inner hole which contains the central turbine blades 23 are made to be communicated with the inner ring hole or the inner hole which contains the turbine guide blades 15. Generally, the outer diameter of the end portion (tip portion) of the turbine blade 21 is gradually reduced from the front to the rear. The inner diameter (root portion) is used to connect the central turbine retaining ring 22 enlarged from the front to the rear. Said end portion matches the air intake guide ring 16, which is conically converged and has approximately the same inclined angle as the cone-shaped air intake guide ring.

The internal combustion engine 3 is a kind of engine with crankcase, and its output shaft is connected to the central turbine. The fuel tank 4 is a streamlined fuel tank with rather light weight, there are provided two props on the top of the fuel tank 4 to fix the controlling servo used for controlling the throttle of the engine, in which the servo is an independent unit which outputs power and which is remote controllable, and on the top of the tank 4 are also provided an oil outlet, an air filling port and an oil supplementing port. The internal combustion engine 3 and the fuel tank 4 can be easily and accurately mounted on the fixing support 13 of the fan duct stator 1 by screws, and the oil inlet port of the internal combustion engine 3 is communicated with the outlet port of the fuel tank 4 via oil intake pipe 41. The air inlet port is connected to the air filling port through the air filling pipe 42, while the oil supplementing port of the fuel tank has the oil supplementing pipe 43 with a plug 44.

The tail cap 5 is a cone-shaped cap, a clipping port is provided at its front portion for fixing a rubber sealing washer or rubber seal. The tail cap 5 is mounted in a sealed manner on the rear end of the fuel tank 4 by a pair of mobile buckles (buckling positions) oppositely disposed. With such a mounting method, the tail cap can be easily mounted on or dismounted from the fuel tank 4, i.e. the mounting and repairing are very convenient. With the combination of the tail cap 5 with the streamlined fuel tank, which is of a simple structure design, light weight results in, what is more important, it can concentrate the rearward expelled air flow at high speed to prevent the occurrence of disordered air flow.

The air expelling duct 6 is a round-shaped thin duct, the inner diameter of which is gradually reduced or gradually converged from the front to the rear in order to speed up the speed of the expelled air flow. A protruding buckle (buckling position) is provided on each of the two oppositely positioned upper and lower sides of the rear end port of the fan duct stator 1 and a recessed buckle (buckling position) is provided on each of the two oppositely positioned upper and lower sides of the front end port of the air expelling duct 6 too, the air expelling duct 6 is fixed on the rear portion of fan duct stator through the engagement of the recessed buckle thereof with the protruding buckle of the fan duct stator. In addition, on the top end of the front portion of the air expelling duct 6 is provided a round hole 61 which is used to let the pass of the igniter for starting the engine 3 and to energize the pre-heater on the top of engine 3.

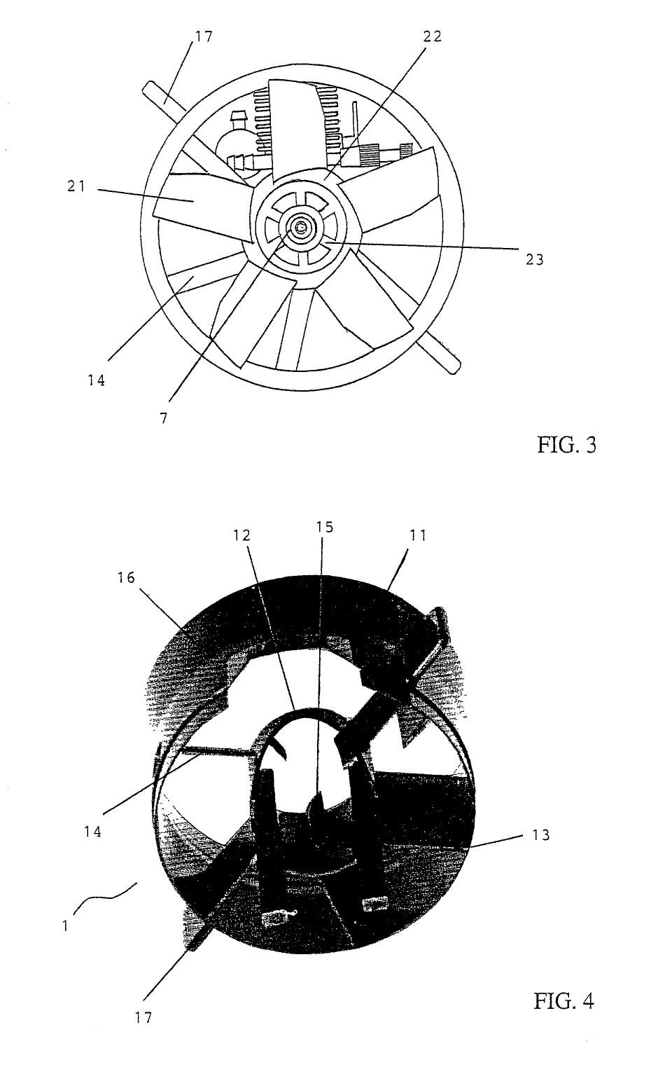

The number of the stator guide blade 14 of the fan duct stator 1 is generally 3-8. In FIG. 3, the number of the blades is 5, for the high power model airplane, the number can be 6 or more. The number of the turbine guide blades 15 is generally 2-6, in FIG. 4, the number of the turbine guide blades is 3, similarly for high power model airplane the number can be 5 or more. The five turbine blades 21 of the central turbine 2 in the embodiment are specially designed according to the air dynamics. The number of the central blades 23 of the turbine is 4-10, generally 6 blades, for high power model airplane the number can be 8 or more, as shown in FIG. 3 and FIG. 4.

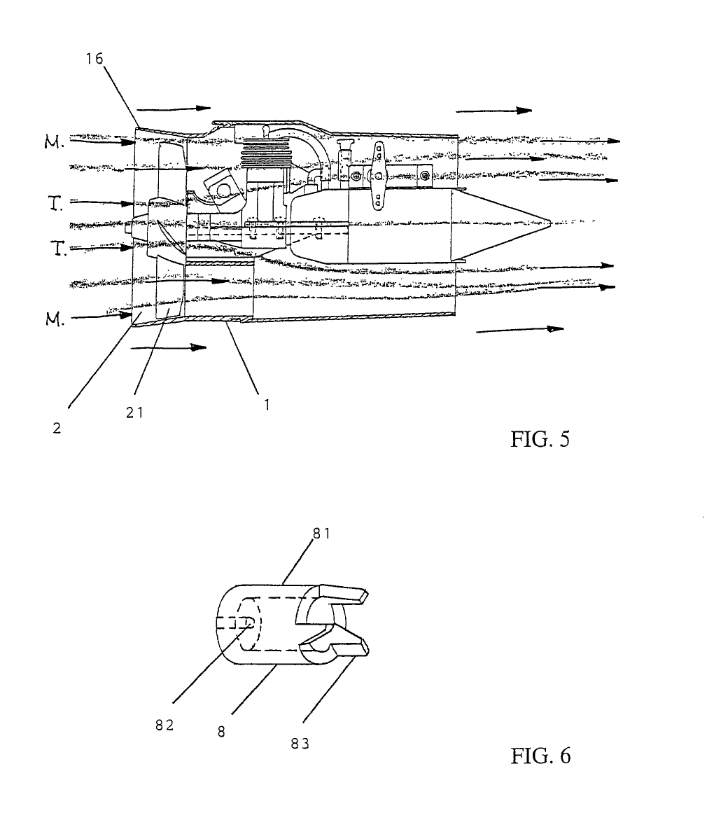

Please refer to FIG. 5, in which the operation principle and of the central turbo ducted fan integrated power plant unit is shown. The unit produces basically two air streams when operating, i.e. a main air stream M and a jetted air stream T of the central turbine. The main air stream M and the jetted air stream T of the central turbine, after passing through the inner ring 12 and the crankcase of the engine 3 are joined together with the surrounding main air stream M. Generally, after the engine is started, the engine actuates simultaneously the turbine blades 21 and the central turbine blades 23. On the one hand, the rotation of the turbine blades 21 makes the taken-in air flow pass through the cone-shaped intake ring 16 with gradually narrowed cross section, during this course or process, because the air is compressed, the speed of the air flow is raised, thereby the efficiency is improved. On the other hand, the rotation of the central turbine blades 23 takes in the air, this air subject to the centrifugal force generated by the rotation of the central turbine, is speeded up to be expelled rearward to generate the jetted air stream by the central turbine. Thus, the turbine blades rotate synchronously with the central turbine blades and the main air stream M and the jetted air stream T of the central turbine are expelled rearward simultaneously, thereby, the expelled air volume and the speed of the air flow are increased and the efficiency is raised correspondingly. During the above mentioned operational process of the central turbine, the stator guide blades 14 of the fan duct stator 1 can guide the rotated air flow generated by the central turbine ducted fan to be expelled linearly and rearward, while the turbine guide blades 15 guide the rotated jetted air stream generated by the rotation of the central turbine to be expelled linearly and rearward. Said expelled air stream can cool directly the crankcase of the engine and can prevent main air stream M from generating disordered air flow when it leaves the inner ring of the stator and is expelled at high speed. In the unit, a controlling built-in servo is provided for controlling fuel tank and the throttle of the engine. Such servo is an independent member which can output power and can be remotely controlled.

Please now refer to FIG. 6, the central turbo ducted fan integrated power plant according to the present utility model also includes a pawl wheel starter 8 which can help to start more easily the unit. The starter 8 is a cylindrical member 81 with a bottom portion, a connecting hole 82 is provided on the bottom portion of the cylindrical member, which hole 82 is used for connecting the external motor, and three protruding teeth 83 are provided on the end face of the open port which teeth are formed integrally, each of teeth 83 has an inclined face with a certain inclining angle.

What is claimed is:

1. A central turbo ducted fan integrated power plant unit, it comprises:
a central turbine having turbine blades and a turbine blade retaining ring, a fan duct stator, an internal combustion engine, a fuel tank and an air expelling duct, characterized in that, in the retaining ring several central turbine blades are provided, said fan duct stator has an outer ring and an inner ring which are connected through some connecting bars, and a fixing support provided on two sides of the inner ring, on which the internal combustion engine and fuel tank are disposed, said central turbine is mounted on the fan duct stator by means of a cone-shaped cover, and is mounted in such a manner that the guide hole which contains central turbine blades is communicated with the inner hole of the inner ring which contains the connecting bars.

2. The central turbo ducted fan integrated power plant unit as claimed in claim 1, characterized in that, the connecting bars of said fan duct stator are stator guide blades, and several radially and uniformly spaced turbine guide blades are also provided on the inside surface of the inner ring.

3. The central turbo ducted fan integrated power plant unit as claimed in claim 1, characterized in that, on the front end of the fan duct stator is provided a central air intake guide ring with diameter or inner diameter being reduced gradually from the front toward the rear.

4. The central turbo ducted fan integrated power plant unit as claimed in claim 1, characterized in that, it also comprises a tail cap for the fuel tank, said tail cap is mounted on the rear end of the fuel tank.

5. The central turbo ducted fan integrated power plant unit as claimed in claim 1, characterized in that, the outer diameter of the end portion of the turbine blades is reduced gradually from the front to the rear and has approximately the same inclined angle as the inner wall of the cone-shaped air intake guide ring.

6. The central turbo ducted fan integrated power plant unit as claimed in claim 1, characterized in that, the retaining ring of the central turbine is of a conical shape, the number of the central turbine blades in the retaining ring is 4-10.

7. The central turbo ducted fan integrated power plant unit as claimed in claim 1, characterized in that, on the outer ring of the fan duct stator the power plant unit fixing member are provided.

8. The central turbo ducted fan integrated power plant unit as claimed in claim 1, characterized in that, the number of the turbine guide blades of the fan duct stator is 2-6.

9. The central turbo ducted fan integrated power plant unit as claimed in claim 1, characterized in that, the number of stator guide blades of the fan duct stator is 3-8.

10. The central turbo ducted fan integrated power plant unit as claimed in claim 1, characterized in that, the inner diameter of the air expelling duct is gradually reduced from the front to the rear.

11. The central turbo ducted fan integrated power plant unit as claimed in claim 1, characterized in that, also comprises a pawl wheel starter which can help to start more easily the unit, the starter is a cylindrical member with a bottom portion, a connecting hole is provided on the bottom portion of the cylindrical member, which hole is used for connecting the external motor, and three protruding teeth are provided on the end face of the open port which teeth are formed integrally, each of teeth has an inclined face with a certain inclining angle.
